(19) United States
(12) Patent Application Publication
(10) Pub. No.: US 2019/0269155 A1
(43) Pub. Date: Sep. 5, 2019

(54) LIQUID SINGLE SERVING COMPOSITION WITH A DAIRY COMPONENT, CEREALS AND FRUITS

(71) Applicant: NESTEC S.A., Vevey (CH)

(72) Inventors: Marine Sarah Ihotse Deck, Bern (CH); Virginie Martinet, Bern (CH); Claire Qiou Ren, Bern (CH)

(21) Appl. No.: 16/332,249

(22) PCT Filed: Sep. 14, 2017
(86) PCT No.: PCT/EP2017/073201

§ 371 Date: Mar. 11, 2019

(30) Foreign Application Priority Data
Sep. 16, 2016 (EP) 16189233.6

(51) Int. Cl. A23L 2/52; A23L 33/21; A23C 9/154; A23L 7/10; A23L 19/00; A23L 33/00; A23L 33/16; A23L 33/155

(52) U.S. Cl. CPC A23L 2/52; A23L 33/21; A23C 9/154; A23L 7/198; A23V 2002/00; A23L 33/40; A23L 33/16; A23L 33/155; A23L 19/09

(57) ABSTRACT

The present invention relates to a liquid single serving composition comprising a cereal component, a dairy component, a fruit component and an additional soluble fibre and to a process of making such composition. The invention also relates to the use of the composition for providing nutrition to a child in the morning and its use for preventing a child from fasting in the morning.

### FIELD OF THE INVENTION

The present invention relates to a liquid single serving composition comprising a cereal component, a dairy component, a fruit component and an additional soluble fibre and to a process of making such composition. The invention also relates to the use of the composition for providing nutrition to a child in the morning and its use for preventing a child from fasting in the morning.

### BACKGROUND OF THE INVENTION

Breakfast is often designated as the most important meal of the day. This is especially true for children, who are in need of essential nutrients in order to face the activities of the day, and namely school-aged children. However, it often happens that people are reluctant to eat in the morning or even skip breakfast. Many children, for example, skip breakfast regularly due to lack of time or appetite. This phenomenon is becoming more and more important because parents often have limited time to prepare their children for school.

For example, Jackson L W; The most important meal of the day: why children skip breakfast and what can be done about it; Pediatr Ann. 2013; 42(9):184-7 teaches that children who consume high fibre and high calcium breakfast have a lower body mass index and are less prone to weight gain.

Julie M. Jones: “Cereal nutrition” In: “Breakfast cereals and how they are made” 2000, AACC International, describes the role of breakfast cereals, such as porridges or ready-to-eat cereals, in life stage and lifestyle. It discusses the benefits of breakfast and of consuming cereals at breakfast. It also discusses the nutritional contribution of breakfast cereals. This review reports nutritional information in connection with ready-to-eat breakfast cereals, with instantized cereals or with cereals which require cooking. Examples of oat flakes and oat groats are disclosed in XP055343746. These documents do not discuss liquid compositions.

WO 2004/086878 A2 discloses a dietary fiber material obtained enzymatic hydrolysis of cereal grains. As a food ingredient, the material can have high R-glucan content which provides nutrient to the body. Because the dietary fiber material can have neutral mouthfeel, it can be used to enhance the nutritional content of ice cream, yogurt, baked goods, bars, beverages, or certain other foods, without affecting the taste or other sensory attributes of the food. As a further benefit, the dietary fiber material can be used to provide certain therapeutic benefits, such as anticholesterol activity.

WO 2010/025000 A1 relates to a sweetened juice beverage comprising beta-glucan.

EP 2110025 A1 relates to a cereal-based instant drink. In particular, the drink may be prepared by adding a roller-dried cereal composition into a cold liquid.

Rampersaud G C, Pereira M A, Girard B L, Adams J, Metzl J D.; Breakfast habits, nutritional status, body weight, and academic performance in children and adolescents; J Am Diet Assoc. 2005; 105(5):743-60 teaches that children who reported eating breakfast on a consistent basis tended to have superior nutritional profiles than their breakfast-skipping peers. Consumption of a healthful breakfast on a daily basis consisting of a variety of foods, especially high-fibre and nutrient-rich whole grain, fruits and dairy products is described as desirable.

Cardiometabolic risks have also been associated with skipping breakfast (see Smith K J, Gall S L, McNaughton S A, Blizzard L, Dwyer T, Venn A J; Sk; Skipping breakfast: longitudinal associations with cardiometabolic risk factors in the Childhood Determinants of Adult Health Study; Am J Clin Nutr. 2010; 92(6):1316-25.

An alternative to the ideal breakfast described in the above publications is needed for those who cannot have a proper breakfast. It is therefore desirable to provide a composition suitable as a full breakfast replacement product, which would be convenient, require a short preparation time, while providing adequate nutrients to the consumer, in particular to school aged children. It would further be desirable to render such a product appealing for children even though they lack appetite in the morning.

A complete breakfast should ideally comprise a dairy product, cereal and fruit. Little prior art relates to compositions that would be more convenient and rapid than traditional breakfast, while providing all adequate nutrients at breakfast (breakfast replacement products). A few products are already available to consumers from the shelf. For example the product Carnation Breakfast Essentials aims at providing a drink that can be used in place of a conventional breakfast. However, this product is not specifically targeted to the nutritional needs of school aged children. It would therefore be desirable to provide compositions specially adapted to the needs of such children.

Milk products intended for children and fortified with specific nutrients such as vitamins and minerals are known. However, these products are not suitable as breakfast replacement for children, namely because they lack cereal, fibre and fruit components.

High amounts of fibre are known to be difficult to include into milk products, namely because of viscosity issues. To solve this viscosity issue, fibres have been hydrolysed. It would however be desirable to use intact fibre that can still be incorporated in dairy product without stability or processing issues.

Soluble corn fibres have been identified as suitable for incorporation in dairy products and breakfast cereals, for example in WO2008/085529. However, no specific composition targeting the needs of children at breakfast is disclosed.

Children who are reluctant to eat in the morning, often called picky eaters, need special food in the morning that is appealing, does not appear too filling and provides the right level of satiation, while containing the appropriate nutrients.

There is currently no composition available fulfilling all the requirement of a complete breakfast replacement, with an appropriate nutritional content and energy content to be used as sole nutrition for children between 4 and 10 years old in the morning, which is at the same time in a convenient format for rapid consumption and is suitable for children who are reluctant to eat in the morning. The present invention aims at solving this problem.

### SUMMARY OF THE INVENTION

In a first aspect, the invention provides a liquid single serving composition comprising 5 to 15 wt % of a cereal component, a dairy component, 4 to 25 wt % of a fruit component and an additional soluble fibre, wherein the caloric content is of at least 150 KCal, the total protein content is of at least 3 wt % and at most 15 wt %, and the total fibre content is of 2 to 6 wt %, based on the total weight of the single serving composition, and wherein total weight of the milk solids represent 40 to 60 wt % of the total solids of the single serving composition.

In a second aspect, the invention provides a process for preparing a liquid single serving composition according to the invention comprising

a) admixing the ingredients to form a liquid composition,

b) submitting the composition to a sterilization process, and

c) filling the composition in singe serving packages.

In a third aspect, the invention relates to the use of a liquid single serving composition according to the present invention for providing nutrition to a child in the morning.

In a third aspect, the invention relates to the use of a liquid single serving composition according to the present invention for preventing a child from fasting in the morning. Alternatively it provides a liquid single serving composition of the invention for use in a method to prevent a child from fasting in the morning.

In a fourth aspect, the invention provides for the use of a liquid single serving composition of the invention as a breakfast replacement beverage.

### DESCRIPTION OF THE FIGURES

FIG. 1 shows a drawing of a viscometer suitable to the measurement of the flowtime of a liquid composition according to the invention. Dimensions are indicated in [mm].

### DETAILED DESCRIPTION OF THE INVENTION

### Liquid Single Serving Composition

The liquid single serving composition of the present invention is specifically aimed at children, preferably school-aged children, more preferably children between 4 and 10 years old. Most preferably, it is for children who are reluctant to eat in the morning and/or children who tend to skip breakfast. Children, in particular in the range or 4 to 10 years old, are often keen to skip breakfast, due to lack of time or of appetite. In such circumstances, a liquid single serving composition is advantageous over eatable breakfast, such as breakfast cereals, in that it can be consumed in a shorter time and even on the go. A ready-to-drink liquid composition provided as a single serving is also very convenient and rapidly available, as it does not require any dosing or preparation. Thus it ensures that lack of time will not prevent the child from having breakfast and that no error can be done in the selection of the amount need for an appropriate meal size. A liquid composition will also be more appealing than solid food to a child that has little appetite.

As the beverage of the present invention has a nutritional profile tailor-made to meet the nutrient requirements of an active child in the morning, this beverage is very advantageous as replacement of a traditional breakfast, for example a breakfast comprising a glass of milk, fruit and cereal.

The single serving composition is also preferably provided in a small format that can easily be consumed in a short time by a child, even with low appetite. The serving size is thus preferably of 180 to 300 ml, preferably 180 to 250 ml more preferably 200 to 250 ml. Such serving size is advantageous in that it is large enough to achieve the required caloric content and to incorporate all required ingredients in sufficient amounts, and in particular sufficient amounts of cereals, without increasing the viscosity in an inacceptable manner. Smaller serving size are less advantageous because it is difficult to include all the required nutrients and the required energy content in such a small volume. The cereal, protein and fibre content are namely difficult to achieve if the volume is too small. Larger volumes would be disadvantageous in that the serving size would be too large for a child that is reluctant to eat (picky eater) would tend to refuse to consume too large a composition or would consume it only in part, thus missing part of the essential nutritional content. A higher volume would also be unsuitable for children that have very little time to eat or who need to eat on the go because larger volumes requires more time to be consumed. In sum, the above volume ranges are advantageous in that the serving is large enough to include all required nutrients and energy and small enough to be appealing to a picky eater child and to be consumed rapidly and/or on the go.

The single serving composition is advantageously provided in a convenient format like a bottle or brick that is easy to take away. Preferably it is provided with a straw to make the format of the product more appealing and beverage-like to the child lacking appetite.

The texture of the liquid single serving composition of the invention is preferably fine-tuned to fit the purpose of providing a filling sensation, while being appealing to a child that is reluctant to eat in the morning or has little appetite. The texture of the composition of the invention can be advantageously characterized by the time that the composition takes to flow through a calibrated viscometer (herein after referred to as “flowtime”).

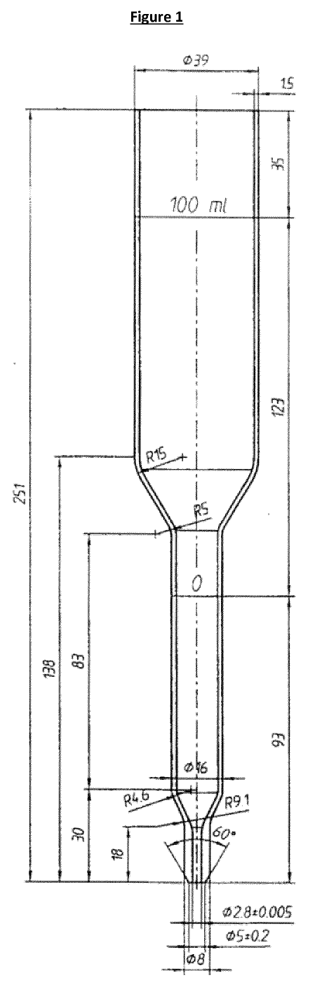

For the purpose of the present invention the term “flowtime” refers to the time required for 100 ml of liquid composition to flow through a glass efflux viscosimeter as depicted in FIG. 1, at 20° C. Such device consists of a glass cylinder with two guide marks, delimiting 100 ml. The lower end is a calibrated capillary tube. Such a viscosimeter can be ordered from diverse suppliers, for example from Gerber instruments AG, Im Langhang 12, 8307 Effretikon, Switzerland.

The liquid single serving composition of the present invention is preferably characterized by a flowtime of 20-50 s, preferably 20-40 s, more preferably 20-35 s and most preferably of 20-30 s. Such flowtime range is advantageous because it is associated with a viscosity that is low enough to be consumed like a beverage, optionally with a straw, so that it is not perceived as a solid food by a child lacking appetite. At the same time, it is high enough to provide sufficient satiation to the child, even to a child that would not be per se reluctant to eat in the morning, but that has no time for a traditional eatable breakfast. Accordingly, the satiation is sufficient to prevent the child from seeking to find other quick food, such as confectionery, in order to quickly get something to eat.

The person skilled in the art looking for an appropriate breakfast solution for picky eaters or for children which do not have time to eat in the morning is faced with opposite problems.

The invention provides a fine balance between opposite requirements for two specific categories of children. For picky eaters, which are reluctant to eat in the morning, the product is small and fluid enough for it to be appealing to the child and to be accepted by this consumer. On the other hand, the product is viscous enough to provide appropriate satiation and large enough to provide all required nutrients and energy to ensure satiety of the child and complete balanced nutrition.

The composition of the invention comprises a specific combination of ingredients adapted to fulfil the specific needs of the children consuming it, such as children between 4 and 10 years old. It is particularly difficult to get all the required nutrients in adequate amounts, as well as the required caloric content, in a volume that is sufficiently small for being appealing to a child lacking appetite in the morning, such as described above. In particular, it is a challenge to achieve the right caloric content without introducing excessive amounts of fat and/or sugar, with a sufficient amount of protein and with appropriate viscosity. The amounts of all nutrients are finely defined to meet this objective.

The composition of the present invention comprises a dairy component. The dairy component is selected from milk, milk protein, whey protein, milk cream, yogurt or a combination thereof. Preferably the dairy component is not acidified. Preferably the dairy component is milk combined with milk cream and added milk proteins. The dairy component is preferably present in such an amount that the total weight of the milk solids is of 40 to 60 wt %, preferably 40 to 50 wt % of the weight of the total solids in the composition.

The composition of the present invention also comprises a cereal component. Such cereal component is preferably provided in whole or in part in the form of a whole grain. The cereal component can be provided in different formats such as powder or syrup. Any type of cereal can be used, such as for example wheat, oat or barley. Preferably the cereal is wheat. The cereal is preferably present in the composition of the invention in an amount of at least 1 wt %, preferably at least 2 wt %, more preferably at least 3 wt %, more preferably at least 4 wt %, even more preferably at least 5 wt %. More preferably the amount of cereal is of 5 to 15 wt %, preferably 5 to 10 wt % of the total weight of the composition. Cereal may be hydrolysed in whole or in part. Hydrolysed cereals are advantageous from processing point view, because the control of the viscosity along the process is easier to control.

The amount of fibre provided at breakfast is very important. Thus fibre is provided in the composition of the invention, in addition to the fibre provided by the cereal component. The total fibre amount in the single serving composition, including the fibre from the cereal component and the additional fibre is of at least 2 wt %, preferably at least 2.3 wt %, based on the total weight of the composition. Preferably, there is provided an amount of fibre of at least 5 g in the single serving composition. Amounts of fibre lower than the above-mentioned amounts would be insufficient based on recommended amounts to be consumed at breakfast for children 4 to 10 years old. The maximum amount of fibre to be used is determined by the maximum digestive tolerance for a given fibre, because too high an amount of a fibre may cause for example flatulence. Such amount associated with maximum digestive tolerance may vary from one fibre to another. In a preferred embodiment, the fibre is present in an amount of 2 to 6 wt %, preferably 2.3 to 5.6 wt %, based on the total weight of the single serving composition. Preferably, the fibre is provided in an amount of 5 to 12 g per serving.

The soluble fibre can be any edible carbohydrate composition that is digestion resistant or slowly digestible by the human digestive system and which is soluble in water. In a preferred embodiment, the fibre is derived from starch. The soluble fibre preferably comprises more than 50 wt %, most preferably at least 70 wt %, of linear and non-linear saccharide oligomers on a dry weight basis. The terms “oligosaccharide” and “saccharide oligomers” are used herein to refer to saccharides comprising at least two saccharide units, for example saccharides having a degree of polymerization (“DP”) of about 2-30.

Preferably the concentration of non-linear saccharide oligomers in the soluble fibre is greater than the concentration of linear saccharide oligomers. More preferably, the concentration of non-linear saccharide oligomers is at least twice as high as the concentration of linear saccharide oligomers. Non-linear oligosaccharides include for example isomaltose. This high proportion of non-linear saccharide oligomers reduces the digestibility of the fibre by the gastrointestinal enzymes, so that the fibre can reach the small intestine and provide its full benefit to the consumer. In an embodiment, the concentration of non-linear saccharide oligomers having a degree of polymerization of at least three is at least 25 wt %, preferably at least 50 wt % by weight on a dry solids basis.

In another preferred embodiment, the soluble fibre comprises less than 50 wt %, most preferably less than 20 wt %, of monosaccharides, on a dry weight basis.

In an embodiment, the soluble fibre is a soluble corn fibre. One example of a suitable soluble corn fibre is Promitor® Soluble Corn Fibre 70, which is available from Tate&Lyle, Hoffmann Estates, Ill., USA.

A more detailed description of soluble fibres suitable for the present invention is provided in WO2008/085529, which is hereby incorporated by reference. Such fibres have been found to be well tolerated and to increase calcium absorption, among other benefits. High amounts of fibre can be included in the composition of the invention without adverse effect on the child consuming it, because the above described specific fibre, and in particular the soluble corn fibre, is particularly well tolerated, even in the amounts provided in the composition of the invention.

Alternatively, other fibres can be used, such as inulin or polydextrose.

The composition of the present invention also comprises a fruit component. Fruit can be provided in the form of fruit powder, fruit puree, fruit puree concentrate, fruit juice or fruit juice concentrate. Preferably it is provided in the form of fruit puree or fruit puree concentrate. The fruit component is preferably present in an amount of at least 4 wt %, preferably at least 5 wt %, more preferably at least 10 wt %, most preferably at least 15 wt % of fruit equivalent, based on the total weight of the composition. Preferably, the fruit component is preferably present in amount of at most 25 wt %, more preferably at most 20 wt %. Preferred ranges for the amount of fruit are thus 4 to 25 wt %, more preferably 5 to 20 wt %, even more preferably 10 to 20 wt %, most preferably 15 to 20 wt %. Preferably, the fruit is present in an amount of at least 10 g, more preferably 10 to 45 g per serving. The amount of fruit as described above is the amount of fruit equivalent. Thus if a fruit in dried or concentrated form is used, the amount of fruit includes the amount of dry or concentrated fruit plus the amount of water necessary to reconstitute it to the normal water content of said fruit.

The composition of the present invention also preferably comprises at least one nutrient selected from calcium, vitamin D, iron, vitamin C and mixtures thereof. Preferably the composition comprises calcium, vitamin D, iron and vitamin C. Preferably calcium is provided in an amount of at least 200 mg, more preferably 200 to 320 mg. Vitamin D is preferably provided in an amount of at least 0.75 μg, more preferably 0.75 to 15 μg. Iron is preferably provided in an amount of at least 2 mg, more preferably from 2 mg to 8 mg. Vitamin C is provided in an amount of at least 20 mg, preferably from 20 to 130 mg. Such nutrients are provided at least in part by the dairy, cereal and fruit components. Additional amounts of these nutrients can further be added to the composition separately to reach the required amount.

The liquid single serving composition preferably comprises 1.5 to 4 wt %, more preferably 1.8 to 3.7 wt % of fat, based on the total weight of the single serving composition. Preferably the amount of fat is of 4 to 8 g per serving. The fat can be of dairy or vegetable origin. Preferably, the fat is from dairy origin.

The protein content of the composition of the present invention is of at least 2 wt %, preferably at least 2.3 wt %, more preferably at least 3 wt %, most preferably at least 3.2 wt %, based on the total weight of the composition. Preferably, there is provided an amount of protein of at least 5 g, more preferably at least 7 g in the single serving composition. The amount of protein in the composition of the invention is preferably of at most 15 wt %.

Available carbohydrates can be present in the single serving composition of the invention, for example in an amount of 9 wt % to 17 wt %, 20 to 35 g, more preferably 9.2 wt % to 14 wt %, based on the total weight of the composition. Preferably, there is provided an amount of available carbohydrate of 20 to 35 g, preferably 20 to 30 g per serving. Available carbohydrates are provided naturally by the cereal component, by the dairy component (namely lactose) and by the fruit component. Depending on the desired sweetness further available carbohydrates can be added. It may be desired to provide a low sugar composition in such case, the desired sweetness of the composition can be obtained by adding sweetener, optionally with flavours, instead of sugar. Natural sweeteners and flavours are preferred.

The composition of the present invention advantageously comprises other nutrients such as minerals and vitamins. Zinc can be incorporated, for example in an amount of 1 to 2.4 mg, preferably 1.5 to 2.4 mg, more preferably 1.65 to 2.4 mg. Vitamin A can also be present, preferably in an amount of 100 to 220 μg, more preferably 120 to 220 μg. Vitamin B1 is preferably also present in an amount of 150 to 360 μg, more preferably 180 to 360 μg. Vitamin B2 is preferably present in an amount of 150 to 360 μg, more preferably 180 to 360 μg. Vitamin B12 is preferably present in an amount of 300 to 720 μg, more preferably 360 to 720 μg. Vitamin B6 is preferably present in an amount of 150 to 8000 μg, more preferably 195 to 8000 μg. Folic acid is preferably also present in an amount of 50 to 80 μg, preferably 60 to 80 μg.

For hedonic purposes, diverse flavours can be present in the composition. Typically the flavour is a non-savoury flavour, such as for example vanilla, fruit, cream, caramel, chocolate, malt or honey flavour, most preferably a fruit flavour. Such flavours are advantageous in that they render the product more appealing to the child, leading to more wilful consumption of the product, even though the child would be keen to skip breakfast.

The composition of the invention may further comprise stabilizers. For example the stabilizer can be selected from gellan gum, carrageenan, carboxymethyl cellulose, microcrystalline cellulose and mixtures thereof. For example a mixture of carboxymethyl cellulose and microcrystalline cellulose can be used, such as Avicel® RC591 from FMC BioPolymer. The stabilizer has a double effect of stabilizing the liquid composition to avoid phase separation and of providing a thicker texture. The stabilizer is advantageous to obtain the desired texture, as described above, which will provide the adequate filling sensation to the child, without rebutting the child from consuming the product and allowing the child to consume the full serving and thus to consume all the nutrients. When gellan gum is used, it is preferably present in an amount of 0.05 to 2 wt %, 0.05 to 1 wt %, 0.05 to 0.5 wt %, 0.05 to 0.3 wt %, 0.05 to 0.2 wt %, 0.05 to 0.1 wt %, 0.075 to 1 wt %, 0.075 to 0.5 wt %, 0.075 to 0.3 wt %, 0.075 to 0.2 wt % or 0.075 to 1 wt %, most preferably 0.1 wt %. When carrageenan is used, it is preferably present in an amount of 0.01 to 0.2 wt %, 0.01 to 0.1 wt %, 0.01 to 0.05 wt %, 0.01 to 0.03 wt % or 0.01 to 0.02 wt %, most preferably 0.13 wt %. When a mixture of carboxymethyl cellulose and microcrystalline cellulose is used, this mixture is preferably present in an amount of 0.05 to 2 wt %, 0.05 to 1 wt %, 0.05 to 0.5 wt %, 0.05 to 0.3 wt %, 0.05 to 0.2 wt %, 0.05 to 0.1 wt %, 0.075 to 2 wt %, 0.075 to 1 wt %, 0.075 to 0.5 wt %, 0.075 to 0.3 wt %, 0.075 to 0.2 wt % or 0.075 to 0.1 wt %, most preferably 0.1 wt %. All percentages are defined based on the total weight of the single serving composition.

### Process

The liquid single serving composition of the present invention can be prepared by any method that is well-known to the person skilled in the art.

Preferably the process for preparing a liquid single serving composition according to the invention comprises

d) admixing the ingredients to form a liquid composition,

e) submitting the composition to a sterilization process, and

f) filling the composition in singe serving packages.

### Use

The liquid single serving composition of the present invention can be used for the non-therapeutic purpose of providing nutrition to a child, preferably to a school-aged child, such as a child between 4 and 10 years old. Preferably the composition of the present invention is used to provide nutrition to such a child, preferably in the morning, more preferably before going to school or on the go, such as on the way to school. Preferably it is used to provide nutrition to a child as described above, which usually skips breakfast or is reluctant to eat in the morning. As described above, the composition of the present invention has advantageous nutritional properties, which render it particularly suitable to meet the nutritional needs of a child in the morning before starting an active day, such as a school day.

The composition of the present invention can also be used for the purpose of preventing a child from fasting in the morning. As the beverage of the present invention has appealing hedonic properties it is more willfully consumed at breakfast than a traditional eatable breakfast, such as breakfast cereals. In other words, the composition of the present invention is a composition for use to prevent a child from skipping breakfast.

The composition of the present invention, as described above, can also be used as a breakfast replacement beverage, preferably as a full breakfast replacement beverage. In other words, the composition of the present invention can be used as sole source of nutrients in the morning. Preferably, it is for a school aged child, more preferably a child of 4 to 10 years of age. Preferably, the composition replaces a conventional breakfast comprising milk, fruit and cereal.

The present invention will now be described in further details by the way of the following examples.

### Example 1

A liquid single serving composition A was prepared by admixing the following ingredients in the amounts indicated in Table 1. The composition was subjected to direct UHT sterilization process and was then aseptically filled in individual TetraPak® TBA bricks of 200 ml with a straw.

TABLE 1
Composition of the liquid single serving composition A

| Ingredient | Amount (wt %) |
|---|---|
| Liquid skimmed milk 9% SNF | 10.56 |
| Cow Skimmed Milk Powder | 6.24 |
| Liquid Milk Cream | 5.67 |
| Strawberry Puree Concentrate 30-32 Bx | 3.44²⁾ |
| Banana Puree 22-26 Bx | 4.23³⁾ |
| Cereal Base Powder (wheat/wheat whole | 5.44 |
| grain) | |
| Sugar White | 3.50 |
| Promitor ® 70 powder (Soluble Corn | 2.45 |
| Fiber)¹⁾ | |
| Gellan gum⁴⁾ | 0.10 |
| Vitamin and mineral premix | 0.10 |
| Strawberry Flavor | 0.10 |
| Water | 58.17 |
| Total | 100 |

¹⁾Origin: Tate&Lyle, Hoffmann Estates, Illinois, USA
²⁾Corresponding to 14.7% fruit equivalent
³⁾Corresponding to 4.2% fruit equivalent
⁴⁾Kelcogel HM-B, origin: CP Kelco, Atlanta, Georgia, USA

The liquid single serving composition prepared above had an energy content of 207 Kcal. The composition had the nutritional content described in Table 2 below

TABLE 2
Nutritional content of the liquid single serving composition A

| Nutrient | Amount | |
|---|---|---|
| Protein | 7.4 | g |
| Fat | 5.1 | |
| Available carbohydrates | 30.2 | |
| Non digestible fibers | 5.5 | |
| Sodium | 95 | mg |
| Calcium | 226 | mg |
| Iron | 2.1 | mg |
| Zinc | 1.65 | mg |
| Vitamin A | 120 | μg |
| Vitamin D | 0.75 | μg |
| Vitamin C | 20 | mg |

### Example 2

A liquid single serving composition B having reduced sugar content was prepared by admixing the following ingredients in the amounts indicated in Table 3. The composition was subjected to direct UHT sterilization process and was then aseptically filled in individual TetraPak® TBA bricks of 200 ml with a straw.

The liquid single serving composition prepared above had an energy content of 200 Kcal. It also had a flowtime of 30 s. The composition had the nutritional content described in Table 4 below.

TABLE 3
Composition of the liquid single serving composition B

| Ingredient | Amount (wt %) |
|---|---|
| Liquid skimmed milk 9% SNF | 10.56 |
| Cow Skimmed Milk Powder | 6.03 |
| Liquid Milk Cream | 9.00 |
| Strawberry Puree Concentrate 30-32 Bx | 3.12²⁾ |
| Banana Puree 22-26 Bx | 4.23³⁾ |
| Cereal Base Powder (wheat/wheat whole | 5.44 |
| grain) | |
| Promitor ® 70 powder¹⁾ (Soluble Corn | 2.55 |
| Fiber) | |
| Vitamin and mineral premix | 0.10 |
| Flavors | 0.10 |
| Natural sweetener | 0.01 |
| Carrageenan Seakem CM611⁴⁾ | 0.013 |
| Avicel ® RC591⁴⁾ | 0.1 |
| Water | 58.74 |
| Total | 100 |

¹⁾Origin: Tate&Lyle, Hoffmann Estates, Illinois, USA
²⁾Corresponding to 13.3% fruit equivalent
³⁾Corresponding to 4.2% fruit equivalent
⁴⁾Mixture of carboxymethyl cellulose and microcrystalline cellulose, origin: FMC BioPolymer, Philadelphia, Pennsylvania, USA

TABLE 4
Nutritional content of the liquid single serving composition B

| Nutrient | Amount | |
|---|---|---|
| Protein | 7.23 | g |
| Fat | 7.60 | |
| Available carbohydrates | 22.78 | g |
| Non digestible fibers | 5.56 | g |
| Sodium | 94 | mg |
| Calcium | 222 | mg |
| Iron | 2.45 | mg |
| Zinc | 1.65 | mg |
| Vitamin A | 120 | μg |
| Vitamin D | 0.75 | μg |
| Vitamin C | 20 | mg |

1. A liquid single serving composition comprising 5 to 15 wt % of a cereal component, a dairy component, 4 to 25 wt % of a fruit component and an additional soluble fiber, wherein the caloric content is of at least 150 KCal, the total protein content is of at least 3 wt % and at most 15 wt %, and the total fiber content is of 2 to 6 wt %, based on the total weight of the single serving composition, and wherein total weight of the milk solids represent 40 to 60 wt % of the total solids of the single serving composition.

2. A composition according to claim 1, for school-aged children.

3. A composition according to claim 1, for children between 4 and 10 years old.

4. A composition according to claim 1, which comprises from 1.5 to 4 wt % of fat based on the total weight of the single serving composition.

5. A composition according to claim 1, wherein the single serving has a volume of 180 to 300 nil.

6. A composition according to claim 1, further comprising at least 200 mg of calcium.

7. A composition according to claim 1, further comprising at least 0.75 μg of vitamin D.

8. A composition according to claim 1, further comprising at least 20 mg of vitamin C.

9. A composition according to claim 1, further comprising at least 2 mg of iron.

10. A composition according to claim 1, wherein the soluble fiber is an edible carbohydrate composition derived from starch that comprises more than 50 wt % of linear and non-linear saccharide oligomers on a dry weight basis.

11. A composition according to claim 1, wherein the viscosity of the composition has a flowtime of 20 to 50 s.

12. A method for providing nutrition to a child in the morning comprising administering a liquid single serving composition comprising 5 to 15 wt % of a cereal component, a dairy component, 4 to 25 wt % of a fruit component and an additional soluble fiber, wherein the caloric content is of at least 150 KCal, the total protein content is of at least 3 wt % and at most 15 wt %, and the total fiber content is of 2 to 6 wt %, based on the total weight of the single serving composition, and wherein total weight of the milk solids represent 40 to 60 wt % of the total solids of the single serving composition to the child in the morning.

13-14. (canceled)
